(19) United States
(12) Patent Application Publication
(10) Pub. No.: US 2014/0067598 A1
(43) Pub. Date: Mar. 6, 2014

(54) ELECTRONIC APPARATUS AND STORAGE MEDIUM

(71) Applicant: KABUSHIKI KAISHA TOSHIBA, Tokyo (JP)

(72) Inventors: Takayuki IIDA, Tachikawa-shi (JP); Kensuke HORIUCHI, Kunitachi-shi (JP); Makito OGURA, Hino-shi (JP)

(73) Assignee: KABUSHIKI KAISHA TOSHIBA, Tokyo (JP)

(21) Appl. No.: 13/870,767

(22) Filed: Apr. 25, 2013

(30) Foreign Application Priority Data
Sep. 5, 2012 (JP) 2012-195262

(51) Int. Cl. G06Q 30/06

(52) U.S. Cl. CPC G06Q 30/0631
USPC 705/26.7

(57) ABSTRACT

According to one embodiment, an electronic apparatus includes a display processor including a recommendation module, a recommendation stop module and a recommendation resumption module. The recommendation module is configured to display a first image representative of an unpurchased content and a second image representative of a purchased content. A series of the unpurchased content is same as a series of the purchased content. The recommendation stop module is configured to stop display of the first image if an input module accepts a first operation for the first image. The recommendation resumption module is configured to resume display of the first image if purchasing one of the same series during a stop of display of the first image.

### CROSS-REFERENCE TO RELATED APPLICATIONS

This application is based upon and claims the benefit of priority from Japanese Patent Application No. 2012-195262, filed Sep. 5, 2012, the entire contents of which are incorporated herein by reference.

### FIELD

Embodiments described herein relate generally to a display control technique.

### BACKGROUND

In recent years, information processing apparatuses, which are battery powered and easy to carry and are used to download (purchase) the data of a digitized book (electronic book) from a content provider via the Internet and read it, are becoming popular. The information processing apparatus of this type is called, for example, an electronic book reader. The content provider that offers the electronic book sales service is called, for example, an electronic book store server.

Image data of a front cover is normally attached to each electronic book. The information processing apparatus of this type displays a list of purchased electronic books in a layout mimicking, for example, a bookshelf using the image data. The user selects the front cover image of an electronic book he/she wants to read from the front cover images displayed in the list and starts reading the desired electronic book.

For example, books called magazines or the like are published periodically, for example, weekly or monthly. For example, books called comics or the like are often published nonperiodically but over an extended period of time. To provide a service for supporting a user who has purchased an electronic book of such a series, many of the information processing apparatuses of this type include a function of, when, for example, an unpurchased subsequent book or a latest book of the series exists, displaying (not only the front cover of the purchased electronic book but also) the front cover of the unpurchased subsequent electronic book to prompt the user to purchase it.

The function of estimating, from the electronic books, a user who purchased something in the past, an unpurchased electronic book he/she is likely to purchase and presenting it is called, for example, a recommendation function. In some apparatuses, the operation of the recommendation function can be enabled/disabled wholly or for each series. There also exist apparatuses capable of both settings, as a matter of course.

For example, assume that a user who has purchased volumes 1 and 2 (electronic books) of a series borrows volume 3 (paper book) from a friend and reads it. That is, volume 3 (electronic book) is unpurchased. In this case, the electronic book reader including the recommendation function displays the front cover of volume 3, for example, adjacent to those of purchased volumes 1 and 2 to prompt the user to purchase volume 3 subsequent to volume 2.

Assume that the user thought that he/she need not purchase the electronic book of volume 3 as he/she had read it (borrowed it from the friend). Also assume that the recommendation function of the user's electronic book reader can enable/disable the operation on the series basis. In this case, the user may disable the recommendation function for that series to hide the front cover of volume 3.

In this case, however, when volume 5 subsequent to volume 4 is published later after the purchase of volume 4 (electronic book), the user cannot receive the support service for notifying him/her of the new publication.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing the outer appearance of an information processing apparatus according to the first embodiment.

FIG. 2 is an exemplary view showing an example of the connection form between the information processing apparatus according to the first embodiment and an external apparatus (content provider).

FIG. 3 is an exemplary block diagram showing the system arrangement of the information processing apparatus according to the first embodiment.

FIG. 4 is an exemplary view showing an example of display of an electronic book list by a bookshelf module of an electronic book application program that operates on the information processing apparatus according to the first embodiment.

FIG. 5 is an exemplary view showing book group unfolding in the electronic book list display performed on the information processing apparatus according to the first embodiment.

FIG. 6 is an exemplary view showing book group folding in the electronic book list display performed on the information processing apparatus according to the first embodiment.

FIG. 7 is an exemplary view showing an example of recommendation display of unpurchased books of series in the electronic book list display performed on the information processing apparatus according to the first embodiment.

FIG. 8 is an exemplary view showing an example of selection rules of unpurchased books to be displayed by recommendation display in the electronic book list display performed on the information processing apparatus according to the first embodiment.

FIG. 9 is an exemplary flowchart showing the basic operation procedure of the electronic book list display performed on the information processing apparatus according to the first embodiment.

FIG. 10 is an exemplary view showing an example of a user interface used to stop recommendation display in the electronic book list display performed on the information processing apparatus according to the first embodiment.

FIG. 11 is an exemplary view for explaining an example in which recommendation display is stopped on the series basis in the electronic book list display performed on the information processing apparatus according to the first embodiment.

FIG. 12 is an exemplary flowchart showing the operation procedure of display processing concerning an unpurchased electronic book executed by the information processing apparatus according to the first embodiment.

FIG. 13 is an exemplary view for explaining an example in which recommendation display is resumed on the series basis in the electronic book list display performed on the information processing apparatus according to the first embodiment.

FIG. 14 is an exemplary flowchart showing the operation procedure of the electronic book list display performed on the information processing apparatus according to the first embodiment (in consideration of resumption of recommendation display).

FIG. 15 is an exemplary first view showing an example of display of a list of electronic files stored in an external storage device stored in a slot, which is performed on an information processing apparatus according to the second embodiment.

FIG. 16 is an exemplary second view showing an example of display of the list of electronic files stored in the external storage device stored in the slot, which is performed on the information processing apparatus according to the second embodiment.

FIG. 17 is an exemplary flowchart showing the operation procedure of display of the list of electronic files stored in the external storage device stored in the slot, which is performed on the information processing apparatus according to the second embodiment.

### DETAILED DESCRIPTION

Various embodiments will be described hereinafter with reference to the accompanying drawings.

In general, according to one embodiment, an electronic apparatus includes a display processor and an input module. The display processor is configured to display a list of images representing contents. The input module is configured to accept an operation for the list of images. The display module includes a recommendation module, a recommendation stop module and a recommendation resumption module. The recommendation module is configured to display a first image representative of an unpurchased content and a second image representative of a purchased content. A series of the unpurchased content is same as a series of the purchased content. The recommendation stop module is configured to stop display of the first image if the input module accepts a first operation for the first image. The recommendation resumption module is configured to resume display of the first image if purchasing one of the same series during a stop of display of the first image.

### First Embodiment

The first embodiment will be described first.

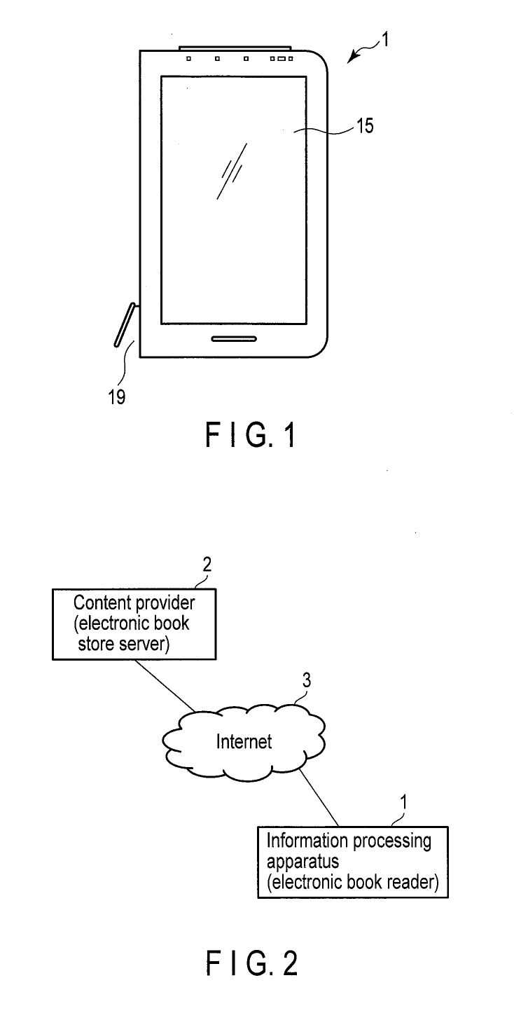

FIG. 1 is an exemplary view showing the outer appearance of an information processing apparatus 1 according to this embodiment. As shown in FIG. 2, the information processing apparatus 1 is implemented as an electronic book reader configured to download (purchase), via the Internet 3, an electronic book from a content provider 2 serving as an electronic book store server for offering an electronic book sales service, and read it.

As shown in FIG. 1, the information processing apparatus 1 includes a touch panel display 15 installed at the center of the front surface of the housing. The touch panel display 15 includes an LCD (Liquid Crystal Display) 15A and a touch panel 15B. A side surface of the housing is provided with a slot 19 used to receive, for example, a micro SD memory card. FIG. 1 illustrates a lid to cover the slot 19. The information processing apparatus 1 includes a wireless communication function using, for example, Wi-Fi and purchases an electronic book from the content provider 2, that is, downloads an electronic book via the Internet 3 using the wireless communication function.

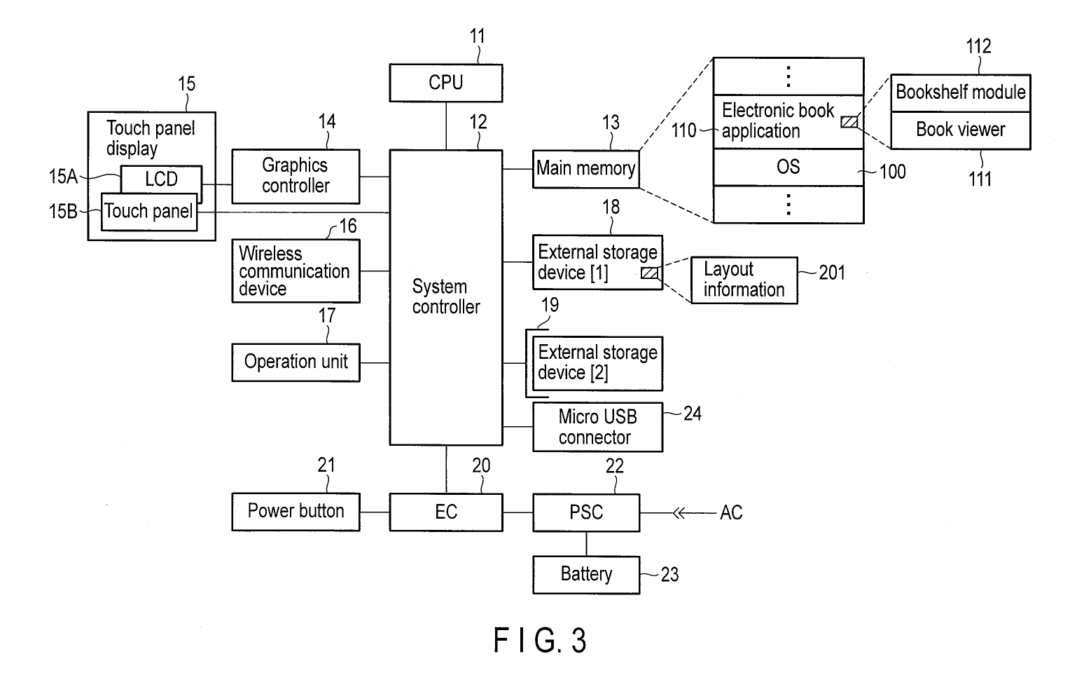

FIG. 3 is an exemplary block diagram showing the system arrangement of the information processing apparatus 1.

As shown in FIG. 3, the information processing apparatus 1 includes a CPU 11, a system controller 12, a main memory 13, a graphics controller 14, the touch panel display 15, a wireless communication device 16, an operation unit 17, an external storage device [1] 18, the slot 19, an EC (Embedded Controller) 20, a power button 21, a PSC (Power Supply Controller) 22, and a battery 23.

The CPU 11 is a processor that controls the operations of various kinds of components in the information processing apparatus 1. The CPU 11 loads various kinds of programs from the external storage device [1] 18 formed from, for example, a flash memory to the main memory 13 and executes the programs. The external storage device [2] shown in FIG. 3 is, for example, a micro SD memory card stored in the above described slot 19. The external storage device [2] is stored in the slot 19 for the purpose of, for example, expanding the area to store the electronic books.

The various kinds of programs executed by the CPU 11 include an OS (Operating System) 100 that controls resource management and an electronic book application program 110 (to be described later) that operates under the OS 100. The electronic book application program 110 includes a book viewer 111 used to read an electronic book, and a bookshelf module 112 used to arrange the electronic books in order such that the user can easily visually recognize the electronic books as if they were actually put on a bookshelf. An example is shown here in which the book viewer 111 exists as one module of the electronic book application program 110. However, the book viewer 111 (for example, existing book viewer) may be implemented as a program different from the electronic book application program 110.

The system controller 12 is a device that connects the local bus of the CPU 11 and the various kinds of components. The system controller 12 incorporates a memory controller which controls access to the main memory 13. The system controller 12 also includes a function of executing communication with the graphics controller 14 via, for example, a serial bus of PCI EXPRESS standard.

The graphics controller 14 is a display controller that controls the LCD 15A used as the display monitor of the information processing apparatus 1. A display signal generated by the graphics controller 14 is sent to the LCD 15A. The LCD 15A displays a screen image based on the display signal. The touch panel 15B is arranged on the LCD 15A. The touch panel 15B is an electrical capacitance type pointing device used to do input on the screen of the LCD 15A. The touch panel 15B detects a contact position on the screen where a finger touches, the motion of the contact position, and the like.

The wireless communication device 16 is a device configured to execute wireless communication using, for example, Wi-Fi. The operation unit 17 is an operation button group arranged on, for example, the peripheral wall of the housing of the information processing apparatus 1.

The EC 20 is a one-chip microcomputer including an embedded controller for power management. The EC 20 includes a function of powering on/off the information processing apparatus 1 in accordance with the user operation of the power button 21 in cooperation with the PSC 22. The PSC 22 is a device that controls supply of operating power to the various kinds of components in the information processing apparatus 1. The PSC 22 also includes a function of charging the battery 23 using power from an external commercial power supply. A micro USB connector 24 is a terminal arranged on, for example, the peripheral wall of the housing of the information processing apparatus 1 to connect a USB device.

When a touch operation is performed on the touch panel display 15 of the information processing apparatus 1 having the above described arrangement, input information including the position on the touch panel 15B is output from the touch panel 15B to the system controller 12. The system controller 12 stores the input information in its own register. The system controller 12 simultaneously generates an interrupt to notify the CPU 11 and causes it to read the input information stored in the register. The occurrence of this event, that is, the touch operation on the touch panel display 15 is thus transmitted to the OS 100. On the other hand, the OS 100 notifies the electronic book application program 110 of the transmitted information concerning the occurrence of the event.

Electronic book display control executed by the bookshelf module 112 of the electronic book application program 110 will be described next.

The electronic book application program 110 includes a function of purchasing an electronic book, a function of displaying a list of purchased electronic books, and a function of reading the electronic books (function of controlling the book viewer 111). The function of displaying a list of purchased electronic books, which is implemented by the bookshelf module 112, will be described here in detail.

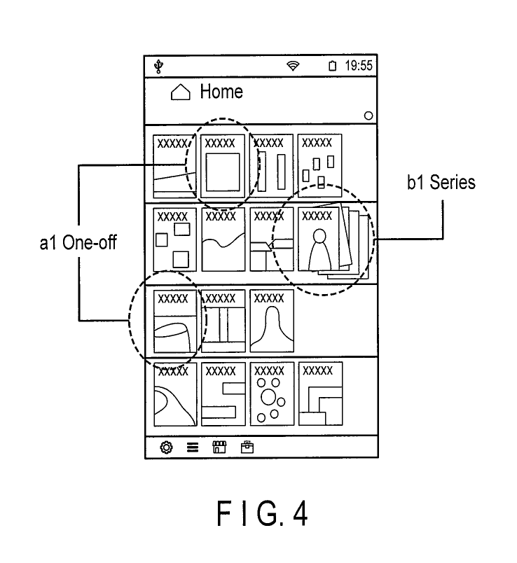

FIG. 4 is an exemplary view showing an example of display of an electronic book list by the bookshelf module 112 of the electronic book application program 110.

The electronic books handled by the electronic book application program 110 are roughly divided into two types: “one-off” and “series”. A one-off is complete in one volume. A series can include books of a single title and different volumes alone. Alternatively, a series may include not only books of a single title and different volumes but also at least one of spin-offs or associated works of the title such as books of special issues, unofficial stories, side stories, and other stories. A magazine or a comic is a series. The magazine has separate books such as “nth month issue” depending on the date of publication under the same title. The comic has separate books such as “volume n” depending on the volume under the same title.

As shown in FIG. 4, the bookshelf module 112 displays one-offs (a1 in FIG. 4) and a series (b1 in FIG. 4) in the same screen. For the series, the plurality of books belonging to the single series are collected at one portion. This collection will be referred to as a “book group”. Books in one book group always belong to a single series, and a one-off or a book of another series is never included. The metadata of an electronic book describes a book ID, title information, publication date information, volume information, and the like. Electronic books having the same title information are defined as a series. The bookshelf module 112 puts the books having the same title information into one book group.

The bookshelf module 112 displays the books (front cover images) in a matrix. The user can arbitrarily set how to arrange the books as if the books were placed on a bookshelf independently of whether they are one-offs or a series. The bookshelf module 112 manages the book arrangement arbitrarily set by the user as layout information 201. The bookshelf module 112 does not limit the number of books that can be arranged on each row (shelf). The bookshelf module 112 does not limit the number of rows (shelves), either. For this reason, the list of books displayed in a matrix can be scrolled in both the vertical and horizontal directions.

Note that the number of books that can be arranged on, for example, one bookshelf may be limited for reasons of memory utilization and the like. In this case, it is preferable to allow the user to freely set the number in the vertical direction (number of shelves) and the number in the horizontal direction (number of books that can be arranged on one shelf) within the limit of the number of books.

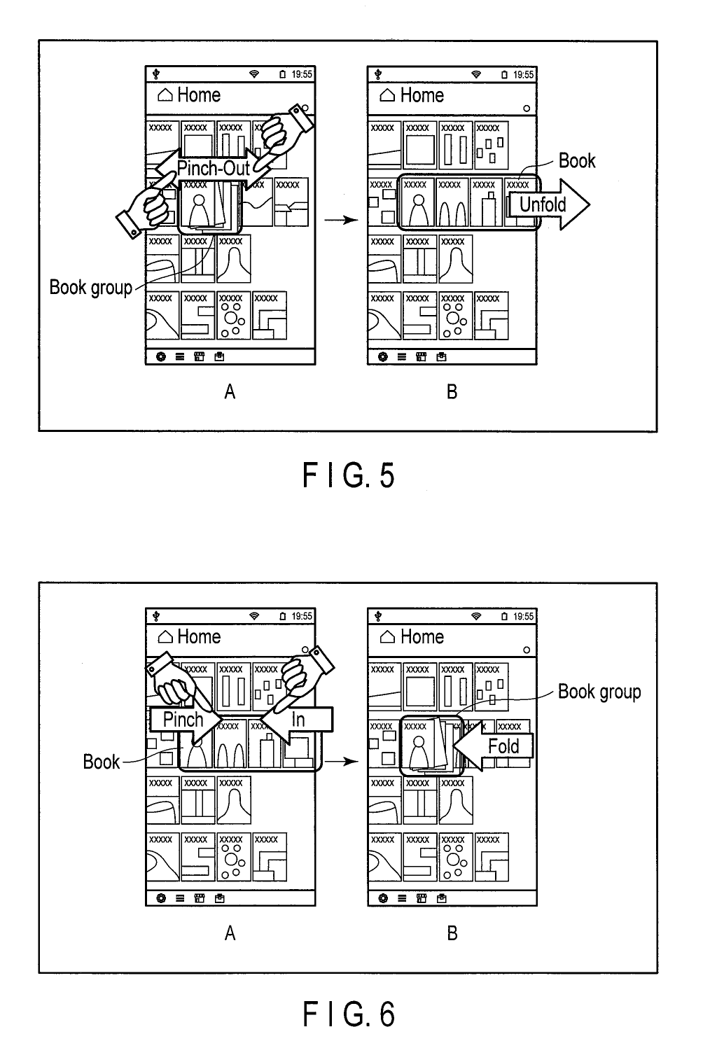

The book group that is a series collection takes two states: “unfolded state” and “folded state”. FIG. 5 shows book group unfolding. FIG. 6 shows book group folding.

In the unfolded state, the user can see the front covers of all books belonging to the same series. On the other hand, in the folded state, the user can confirm only the front cover of one book out of the books belonging to the same series. The remaining books are expressed as if they were stacked under the one book. The books in the book group are sorted in ascending or descending order of volume, and the horizontal relationship in the unfolded state and the vertical relationship in the folded state are determined in that order. The sorting in the book group may be done in an order other than the order of volume.

The change of the book group from the folded state to the unfolded state will be described with reference to FIG. 5. When the user performs the pinch-out operation on the book group in the folded state, the book group changes to the unfolded state. The pinch-out operation is a sliding operation of moving two contact points away from each other on the touch panel display 15. The user can see the change to the unfolded state by an animation effect. However, the animation effect is not essential. The starting point of the change to the unfolded state is the left side of the book at the left end of the book group in the folded state. The books other than the book at the left end are unfolded to the right side in accordance with a predetermined arrangement order. The operation for changing the book group to the unfolded state is not limited to the pinch-out operation and can be any other operation, such as a tap.

The change of the book group from the unfolded state to the folded state will be described next with reference to FIG. 6. When the user performs the pinch-in operation on the book group in the unfolded state, the book group changes to the folded state. The pinch-in operation is a sliding operation of moving two contact points close to each other on the touch panel display 15. The user can see the change to the folded state by an animation effect. However, the animation effect is not essential. The target of the change to the folded state is the center of the pinch-in operation. The center of the width of the book group in the folded state is caused to match the center of the pinch-in operation. The operation for changing the book group to the folded state is not limited to the pinch-in operation and can be any other operation, such as a tap. There are a plurality of methods of determining the center of the pinch-in operation. For example, the center of two coordinate points at the start of the pinch-in operation may be employed.

The bookshelf module 112 includes a recommendation function of, when the books of a series are displayed, and an unpurchased book exists in the series, displaying the image of the unpurchased book adjacent to the purchased books. The bookshelf module 112 acquires volume number information (including whether a book is purchased or yet to be purchased) of each purchased book from the content provider 2 and detects the existence of the unpurchased book of the series.

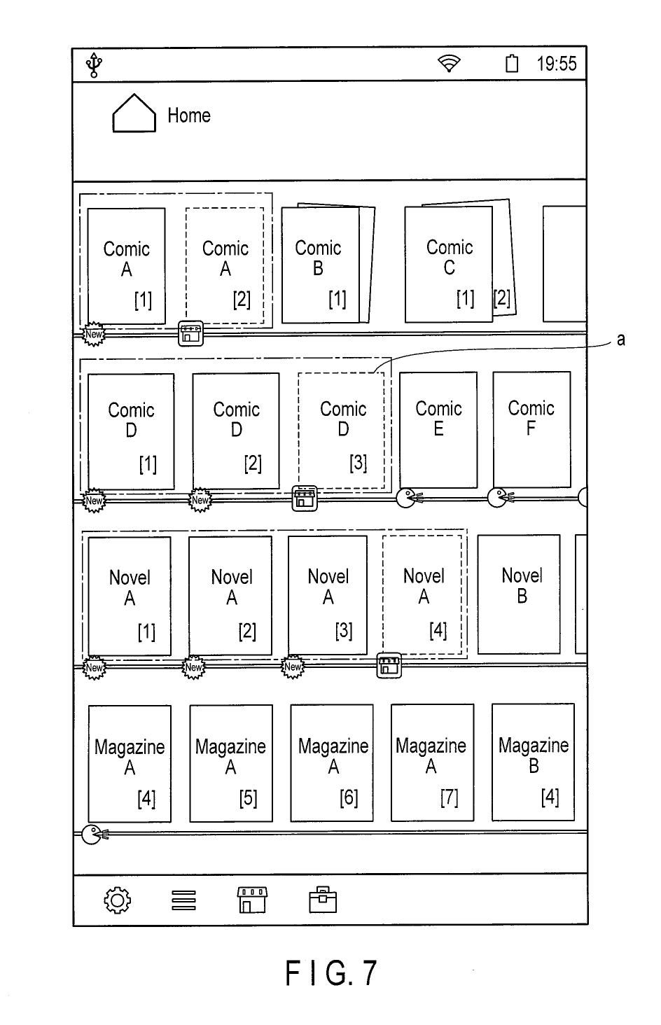

FIG. 7 is an exemplary view showing an example of recommendation display of unpurchased books of a series by the bookshelf module 112.

In FIG. 7, as for “comic A” arranged on the first shelf, volume 1 is purchased, and unpurchased volume 2 exists. As for “comic D” arranged on the second shelf, volumes 1 and 2 are purchased, and unpurchased volume 3 exists. Similarly, as for “novel A” arranged on the third shelf, volumes 1 to 3 are purchased, and unpurchased volume 4 exists. That is, volume 2 of “comic A”, volume 3 of “comic D”, and volume 4 of “novel A” are shown as recommended items by recommendation display.

Note that “comic B” and “comic C” arranged on the first shelf also include the books of the series. However, the books are displayed in the folded state. Even if an unpurchased subsequent book that should be displayed exists, its front cover is not displayed. The recommendation display is done only when the book group has changed to the unfolded state. “Magazine A” on the fourth shelf also includes the books of the series, which are displayed in the unfolded state. However, for “magazine A”, no unpurchased subsequent book exists, or unpurchased books are hidden. The hiding will be described later.

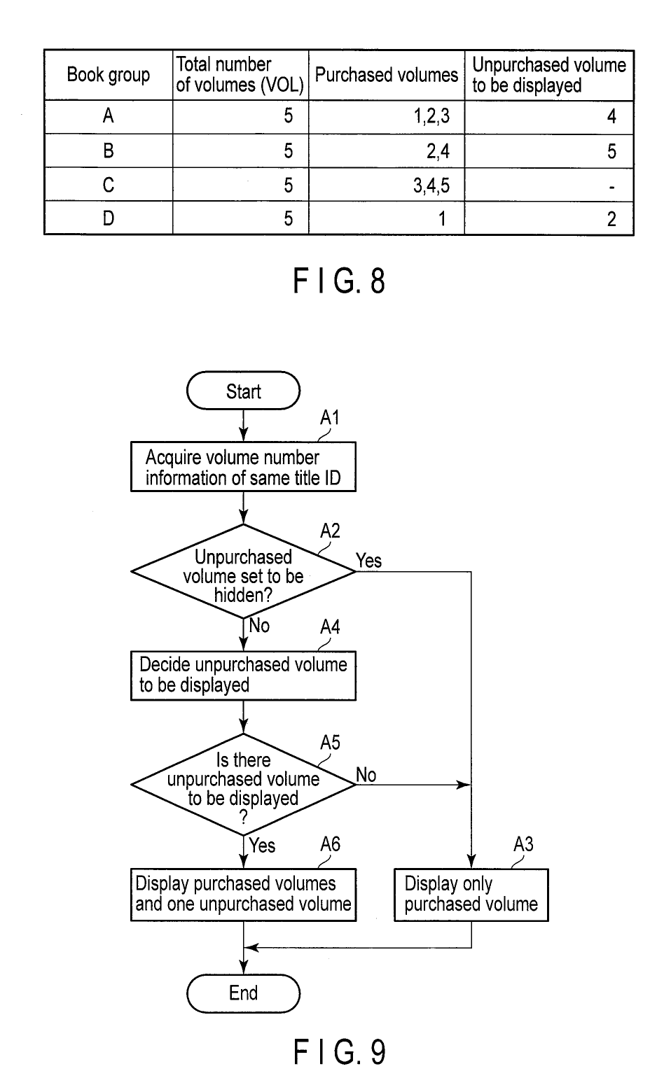

Additionally, since the display area of the touch panel display 15 is limited, the bookshelf module 112 appropriately selects the unpurchased books to be displayed by recommendation display from the unpurchased books of the series. An example of selection rules of the unpurchased books to be displayed by recommendation display of the bookshelf module 112 will be described with reference to FIG. 8.

Simply put, the bookshelf module 112 selects, as a recommendation display target, an unpurchased book having an earliest date of sales out of unpurchased books whose dates of sales are later than those of all purchased books. In the book group (group book) of series A shown in FIG. 8, volumes 1, 2, and 3 are purchased, and volumes 4 and 5 are unpurchased. Hence, volume 4 is the display target. In the book group of series B shown in FIG. 8, volumes 2 and 4 are purchased, and volumes 1, 3, and 5 are unpurchased. Hence, (not volume 1 or 3 but) volume 5 is the display target.

In the book group of series C shown in FIG. 8, volumes 3, 4, and 5 are purchased, and volumes 1 and 2 are unpurchased. Hence, no display target exists. In the book group of series D shown in FIG. 8, volume 1 is purchased, and volumes 2, 3, 4, and 5 are unpurchased. Hence, volume 2 is the display target. An example in which only one book is selected as the display target has been described above. However, for example, two books may be selected at maximum, or the user may be allowed to arbitrarily set the number of books to be selected as the display targets.

FIG. 9 is an exemplary flowchart showing the basic operation procedure of the electronic book list display executed by the bookshelf module 112.

The bookshelf module 112 acquires, for each purchased book, volume number information (including whether a book is purchased or yet to be purchased) of the same title from the content provider 2 (block A1). The bookshelf module 112 checks, for each title, whether unpurchased volumes are set to be hidden (block A2). If the unpurchased volumes are set to be hidden (YES in block A2), the bookshelf module 112 displays only purchased volumes for the title (block A3).

If the unpurchased volumes are not set to be hidden (NO in block A2), the bookshelf module 112 executes selection processing of an unpurchased book to be displayed (block A4). If no unpurchased book to be displayed exists (NO in block A5), the bookshelf module 112 displays only purchased volumes for the title (block A3). If an unpurchased book to be displayed exists (YES in block A5), the bookshelf module 112 displays the purchased volumes and the unpurchased book (block A6).

Needless to say, recommendation display of the unpurchased book is performed to prompt the user to purchase the book. In the information processing apparatus 1, when the user performs the tap operation on the front cover image of the unpurchased book of recommendation display, the screen can transit to a screen to purchase the book from the content provider 2.

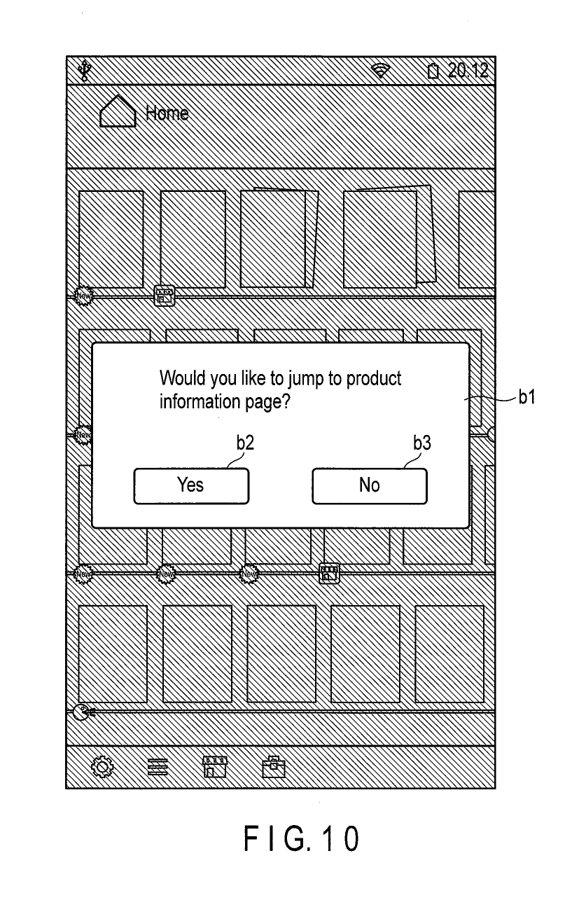

Assume that in a state in which volume 2 of “comic A”, volume 3 of “comic D”, and volume 4 of “novel A” are displayed by recommendation display, as shown in FIG. 7, the user performs the tap operation on the image (a in FIG. 7) of the front cover of volume 3 of “comic D”. Then, the electronic book application program 110 presents a message dialogue (b1 in FIG. 10) to the user, as shown in FIG. 10.

The message dialogue displays a message to confirm whether to transit to the screen to purchase the tapped unpurchased book from the content provider 2. The message dialogue also displays the images of two operation buttons “Yes” (b2 in FIG. 10) and “No” (b3 in FIG. 10). When the user performs the tap operation on the image of the operation button “No”, the apparatus normally recognizes that canceling the immediately preceding operation (tap operation on the front cover image of volume 3 of “comic D”) is instructed.

In contrast, the information processing apparatus 1 recognizes that hiding the front cover image of volume 3 of “comic D” is instructed when the user performs the tap operation on the image of the operation button “No”. Hence, in the information processing apparatus 1, the user first performs the tap operation on the front cover image of the unpurchased book displayed by recommendation display to display the message dialogue shown in FIG. 10. The user then performs the tap operation on the operation button “No” in the message dialogue, thereby disabling the operation of the recommendation display function for the series. In other words, the information processing apparatus 1 uses the message dialogue shown in FIG. 10 also as a user interface to disable the operation of the recommendation display function.

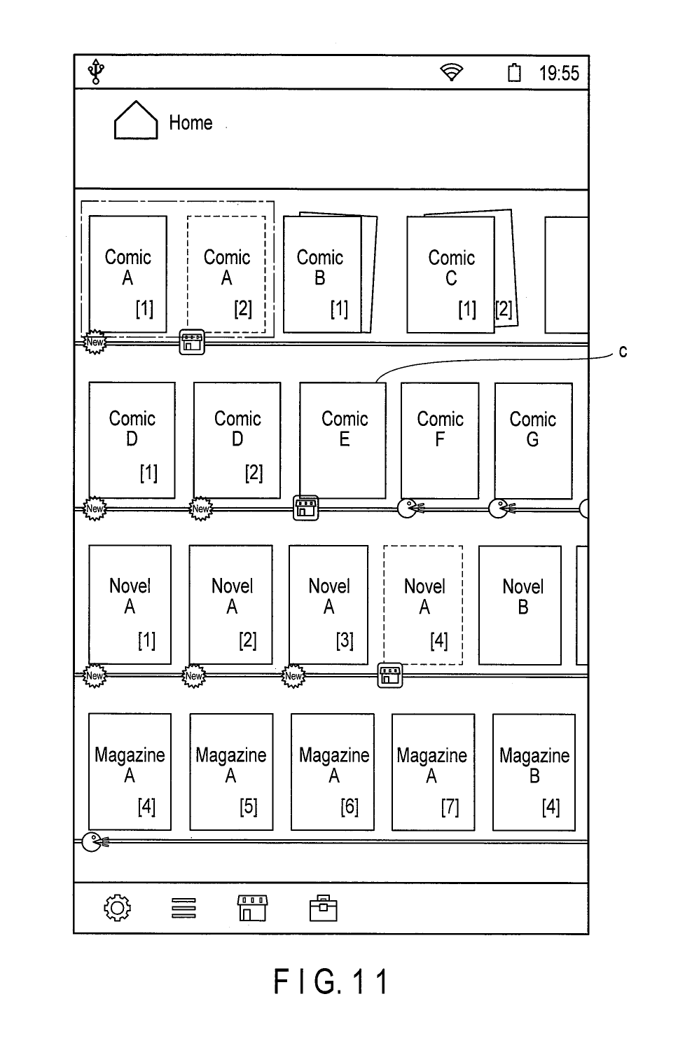

FIG. 11 is an exemplary view showing an example of the electronic book list that is redisplayed by the bookshelf module 112 when the tap operation is performed on the image of the operation button “No” in the message dialogue.

As shown in FIG. 11, the bookshelf module 112 hides the front cover image of volume 3 of “comic D” and slides each book displayed on the right side of the front cover image of volume 3 of “comic D” to the left by a distance corresponding to one book. The front cover image (c in FIG. 11) of “comic E” (single volume) arranged next to its right is displayed at the position where the front cover image of volume 3 of “comic D” was displayed.

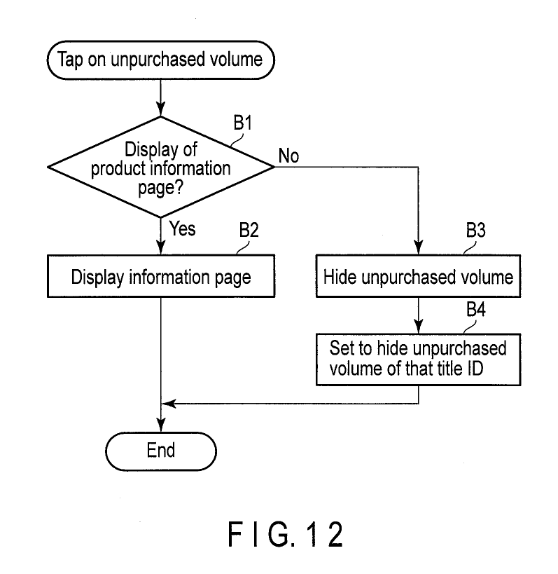

FIG. 12 is an exemplary flowchart showing the operation procedure of display processing concerning an unpurchased book executed by the electronic book application program 110.

When the tap operation is performed on the front cover image of an unpurchased book displayed by recommendation display of the bookshelf module 112, and the message dialogue is displayed, the electronic book application program 110 determines, based on which one of the images of the operation buttons “Yes” and “No” is the target of the tap operation, whether to transit to the screen (product information page) to purchase the unpurchased book (block B1). If the tap operation is performed on the image of the operation button “Yes” (YES in block B1), the electronic book application program 110 displays the product information page (block B2). If the tap operation is performed on the image of the operation button “No” (NO in block B1), the electronic book application program 110 hides the unpurchased book and causes the bookshelf module 112 to redisplay the electronic book list (block B3). In addition, the electronic book application program 110 disables the operation of the recommendation display function for the series (block B4).

A mechanism provided in the information processing apparatus 1 to automatically resume the operation of the recommendation display function for a series, which has been actively disabled by the user, will be explained next.

As described above, in the information processing apparatus 1, the user can purchase the unpurchased book of the same series as that of the purchased book by performing the tap operation on the front cover image displayed by recommendation display. In addition, the information processing apparatus 1 can access the content provider 2 to purchase an arbitrary book independently of the recommendation display function.

Assume that the user who has hidden the front cover image of volume 3 of “comic D” (disabled the operation of the recommendation display function for “comic D”), as shown in FIG. 11, purchases volume 4 of “comic D” independently of the recommendation display function without purchasing hidden volume 3 of “comic D”. Also assume that volume 5 of “comic D” is published after that.

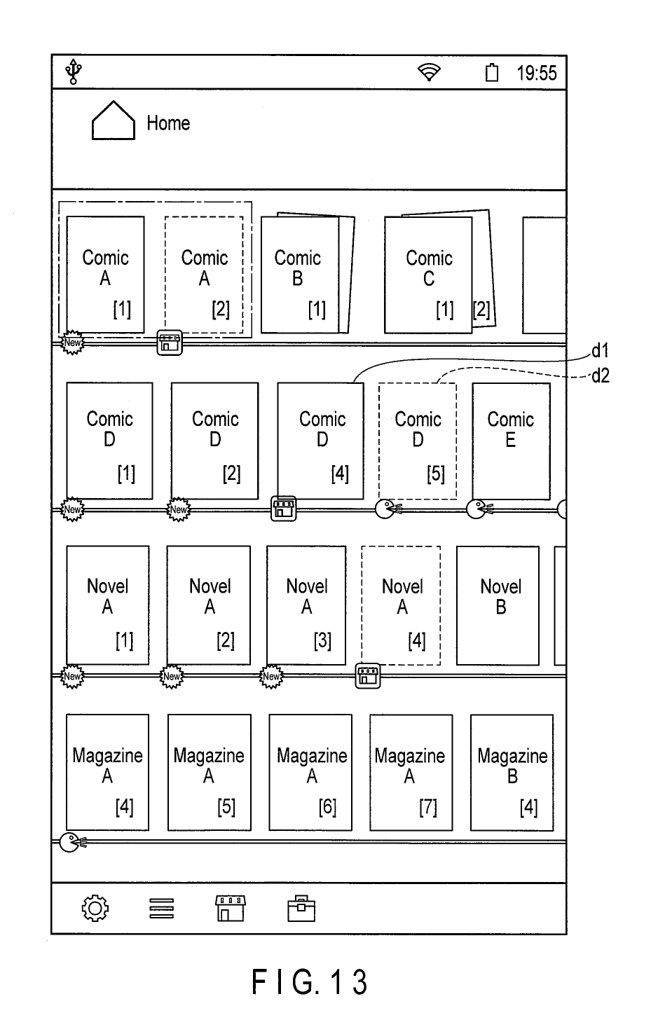

In this case, since volumes 1, 2, and 4 of “comic D” are purchased, and volumes 3 and 5 are unpurchased, volume 5 is the display target (of recommendation display). Since the display target upon disabling the operation of the recommendation display function is volume 3, the display target has changed. With this change, the bookshelf module 112 automatically enables the operation of the recommendation display function for “comic D”. FIG. 13 is an exemplary view showing an example of the electronic book list displayed when the bookshelf module 112 has resumed the recommendation display.

As shown in FIG. 13, the bookshelf module 112 displays the front cover images of purchased volumes 1, 2, and 4 of “comic D”, and simultaneously displays the front cover image (d2 in FIG. 13) of unpurchased volume 5 next to the front cover image (d1 in FIG. 13) of newly purchased volume 4 on its right by recommendation display. Note that when volume 4 is published, volumes 1 and 2 of “comic D” have been purchased, and volumes 3 and 4 are yet to be purchased. Hence, volume 3 is still the display target (of recommendation display) and remains unchanged. This also applies to a case in which volume 5 is published without purchasing volume 3 or 4. The change in the display target occurs when the user has the intention to purchase a subsequent book. Hence, by this change, the bookshelf module 112 cancels the disable state of the operation of the recommendation display function actively set by the user for the series.

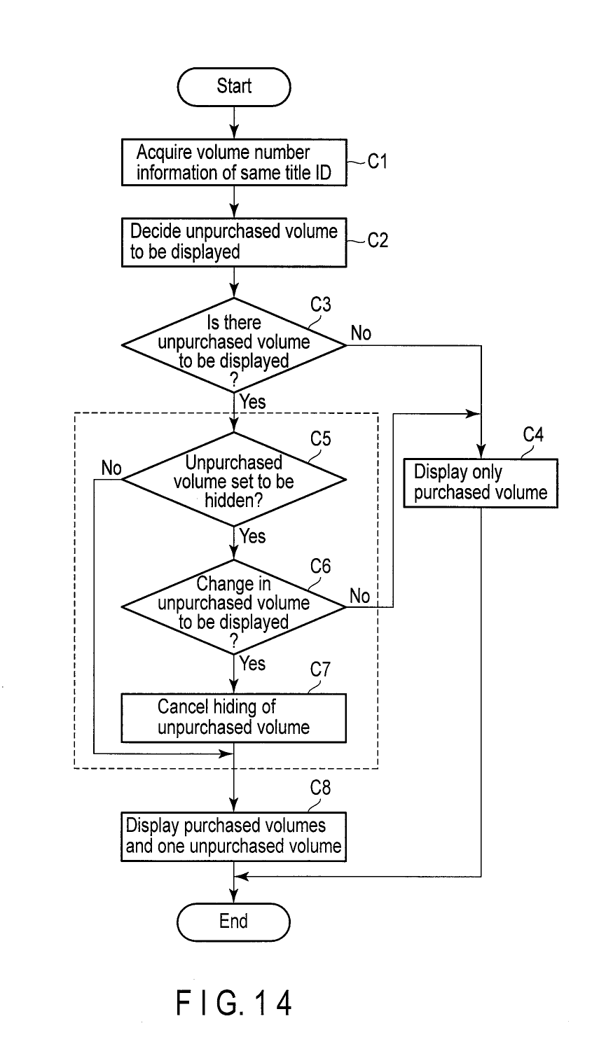

FIG. 14 is an exemplary flowchart showing the operation procedure of the electronic book list display executed by the bookshelf module 112 (in consideration of resumption of recommendation display).

First, the bookshelf module 112 first acquires, for each purchased book, volume number information (including whether a book is purchased or yet to be purchased) of the same title from the content provider 2 (block C1). The bookshelf module 112 executes selection processing of an unpurchased book to be displayed (block C2). If no unpurchased book to be displayed exists (NO in block C3), the bookshelf module 112 displays only purchased volumes for the title (block C4).

If an unpurchased book to be displayed exists (YES in block C3), the bookshelf module 112 checks for the title whether the unpurchased book is set to be hidden (block C5). If the unpurchased book is not set to be hidden (NO in block C5), the bookshelf module 112 displays the purchased books and the unpurchased book (block C8).

If the unpurchased book is set to be hidden (YES in block C5), the bookshelf module 112 checks whether the display target of the unpurchased book has changed (block C6). If the display target has changed (YES in block C6), the bookshelf module 112 cancels the hiding of the unpurchased book for the title (block C7) and displays the purchased books and the unpurchased book (block C8).

As described above, according to the information processing apparatus 1, appropriate control of display of the content (electronic book) list is implemented.

### Second Embodiment

The second embodiment will be described next.

An information processing apparatus according to this embodiment is also implemented as an electronic book reader configured to download (purchase), via the Internet, an electronic book from a content provider and read it, as in the first embodiment. The same reference numerals as in the first embodiment denote the same constituent elements in the second embodiment.

In the first embodiment, for example, a micro SD memory card (external storage device [2]) stored in the slot 19 is used to, for example, expand the area to store the electronic books. In an information processing apparatus 1, the micro SD memory card is also used to view, for example, a PDF file on the information processing apparatus 1. In other words, an electronic book application program 110 that operates on the information processing apparatus 1 includes a function of viewing a PDF file in the micro SD memory card stored in the slot 19 by a book viewer 111.

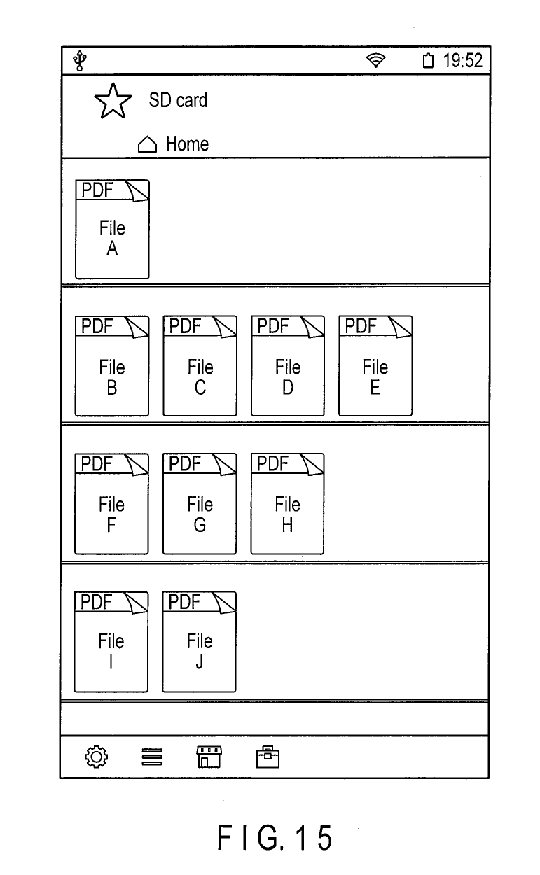

A bookshelf module 112 of the electronic book application program 110 that operates on the information processing apparatus 1 includes a function of displaying a list of PDF files in the micro SD memory card stored in the slot 19 using a layout mimicking a bookshelf, as shown in FIG. 15, like the electronic books purchased from the content provider. The user can arbitrarily set the arrangement of the PDF files as well. The bookshelf module 112 manages the arrangement as layout information 201.

The slot 19 in which the micro SD memory card is detachably stored can receive an indefinite number of micro SD memory cards. Recording the arrangement of PDF files as the layout information 201 for all of the indefinite number of micro SD memory cards is not preferable for management of finite resources. The bookshelf module 112 of the electronic book application program 110 that operates on the information processing apparatus 1 determines whether the micro SD memory card stored in the slot 19 is the same as that stored previously. If the micro SD memory card is the same, the PDF files recorded in the micro SD memory card are arranged and displayed in a list based on the recorded layout information 201. If the micro SD memory card is not the same, the bookshelf module 112, for example, scans the micro SD memory card, arranges the PDF files in the order in which they are found, and displays a list of them.

To implement this determination, the bookshelf module 112 generates a hash value using, for example, the system clock of the information processing apparatus 1. The hash value is recorded in a predetermined folder (if no folder exists, a new one is created) of the micro SD memory card stored in the slot 19 and also recorded in the information processing apparatus 1 in association with the layout information 201 of the PDF files. When the micro SD memory card is stored in the slot 19, the bookshelf module 112 checks whether the hash value recorded in the micro SD memory card matches the hash value recorded in the information processing apparatus 1 in association with the layout information 201 of the PDF files, thereby determining whether the micro SD memory card stored in the slot 19 is the same as that stored previously. If the micro SD memory card is not the same, the bookshelf module 112 discards the layout information 201 of the PDF files. That is, when the same micro SD memory card is continuously stored in the slot 19, the list of PDF files is displayed based on the layout information 201.

The PDF files recorded in the micro SD memory card can be deleted during detachment from the slot 19 of the information processing apparatus 1. A new PDF file can also be added. If the micro SD memory card stored in the slot 19 is the same as that stored previously, and deletion or addition of a PDF file is recognized for the micro SD memory card, the bookshelf module 112 executes display of the PDF file list in an arrangement according to the recorded layout information 201 as much as possible.

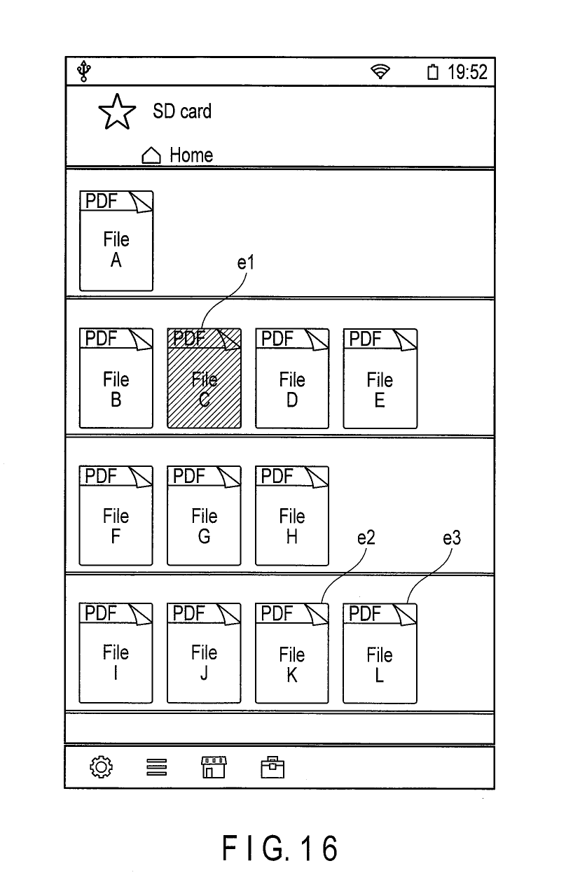

FIG. 16 shows an example of PDF file list display performed by the bookshelf module 112 when the micro SD memory card for which the PDF file list display was performed as shown in FIG. 15 is stored in the slot 19 of the information processing apparatus 1 again.

Referring to FIG. 16, an image (e1 in FIG. 16) of file C represents a PDF file that existed previously but not now, that is, a deleted PDF file. An image (e2 in FIG. 16) of file K and an image (e3 in FIG. 16) of file L represent PDF files that did not exist previously but do now, that is, added PDF files. In this way, the bookshelf module 112 arranges an image representing a deleted PDF file at its original position so as to make the deleted state identifiable, and arranges an added PDF file at the backend of the PDF files that existed previously. Even when a change has occurred in the micro SD memory card, the list of PDF files is thus displayed in a layout close to that of the previous list display.

Note that the deleted PDF file may be deleted from the bookshelf, too, and another PDF file may be moved to the position of the deleted file. The added PDF file may be arranged not at the backend but at the lead (upper left).

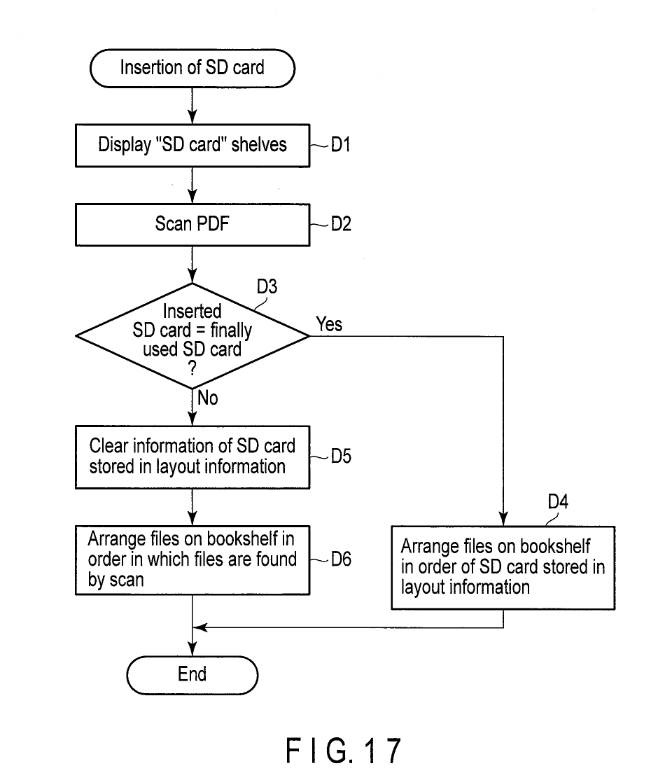

FIG. 17 is an exemplary flowchart showing the operation procedure of display of the list of PDF files stored in the external storage device stored in the slot 19, which is executed by the bookshelf module 112.

When the micro SD memory card is stored in the slot 19, the bookshelf module 112 displays shelves to display the list of PDF files recorded in the micro SD memory card (block D1). The bookshelf module 112 executes a scan of the micro SD memory card to detect the PDF files (block D2).

The bookshelf module 112 checks whether the micro SD memory card stored in the slot 19 is the same as that stored previously (block D3). If the micro SD memory card is the same (YES in block D3), the PDF files found by the scan are arranged and displayed in a list based on the layout information 201 (block D4).

If the micro SD memory card is not the same (NO in block D3), the bookshelf module 112 discards the layout information 201 of the PDF files (block D5), arranges the PDF files in the order in which the files are found by the scan, and displays a list thereof (block D6).

As described above, according to the information processing apparatus 1, appropriately controlling display of the content (PDF file) list while considering management of finite resources is implemented.

Operation control processing of the embodiments can be implemented by software (program). Hence, when the software is installed in a normal computer via a computer readable storage medium storing the software and executed, the same effects as in the embodiments can easily be implemented.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display processor configured to display a list of images representative of contents; and
an input module configured to accept an operation for the list of images,
wherein the display processor comprises:
a recommendation module configured to display a first image representative of an unpurchased content and a second image representative of a purchased content, a series of the unpurchased content being same as a series of the purchased content;
a recommendation stop module configured to stop display of the first image if the input module accepts a first operation for the first image; and
a recommendation resumption module configured to resume display of the first image if purchasing one of contents of the same series during a stop of display of the first image.

2. The apparatus of claim 1, wherein the recommendation module is configured to set, as the first image, at least one unpurchased content of the same series, the at least one unpurchased content comprising an earliest date for sale out of unpurchased contents whose dates for sale are later than those of the purchased contents.

3. The apparatus of claim 1, wherein the recommendation module is configured to display the first image in a form different from that of the second image.

4. The apparatus of claim 1, wherein:
the recommendation stop module is configured to be capable of stopping the display of the first image for each group of contents of the same series; and
the recommendation resumption module is configured to be capable of resuming the display of the first image for each group of contents of the same series.

5. The apparatus of claim 1, wherein:
the content comprises an electronic book, and
the recommendation module is configured to display an image of a front cover belonging to the electronic book.

6. The apparatus of claim 5, wherein the recommendation module, the recommendation stop module and the recommendation resumption module are configured to determine an electronic book whose title information included in metadata of the electronic book is identical as an electronic book of the same series.

7. An electronic apparatus comprising:
a storage module configured to detachably store a storage medium;
a display processor configured to display a list of images representative of files stored in the storage medium stored in the storage module; and
an input module configured to accept an operation concerning an arrangement of the list of images,
wherein the display processor comprises:
a layout storage module configured to store arrangement information representative of the arrangement of the list of the images; and
a layout management module configured to discard the arrangement information stored by the layout storage module, when a second storage medium different from the storage medium stored previously is stored in the storage module.

8. The apparatus of claim 7, wherein the layout management module is configured to
generate a hash value and store the hash value in a first area of the second storage medium stored in the storage module and simultaneously stores the generated hash value in the layout storage module, and
determine whether the second storage medium is the same as the storage medium stored previously by comparing the hash value stored in the first area of the second storage medium with the hash value stored in the layout storage module when the second storage medium is stored in the storage module.

9. The apparatus of claim 7, wherein the display processor is configured to display the list of the images using the arrangement information stored in the layout storage module, when the same storage medium as the storage medium stored previously is stored in the storage module.

10. The apparatus of claim 9, wherein the display processor is configured to arrange an image representative of a deleted file at a position represented by the arrangement information and displays the image so as to make the deleted file identifiable, when a file for which the arrangement of the image is represented by the arrangement information stored in the layout storage module is deleted from the storage medium.

11. The apparatus of claim 9, wherein the display processor is configured to arrange an image representative of an added file at a backend and displays the image, when a file for which the arrangement of the image is not represented by the arrangement information stored in the layout storage module is added to the storage medium.

12. A computer readable, non transitory storage medium having stored thereon a computer program which is executable by a computer, the computer program controlling the computer to function as:
a display processor configured to display a list of images representative of contents; and
an input module configured to accept an operation for the list of images,
wherein the display processor comprises:
a recommendation module configured to display a first image representative of an unpurchased content and a second image representative of a purchased content, a series of the unpurchased content being same as a series of the purchased content;
a recommendation stop module configured to stop display of the first image if the input module accepts a first operation for the first image; and
a recommendation resumption module configured to resume display of the first image if purchasing one of contents of the same series during a stop of display of the first image.

13. The medium of claim 12, wherein the recommendation module is configured to set, as the first image, at least one unpurchased contents of the same series, the at least one unpurchased content comprising an earliest date for sale out of unpurchased contents whose dates for sale are later than those of the purchased contents.

14. The medium of claim 12, wherein the recommendation module is configured to display the first image in a form different from that of the second image.

15. The medium of claim 12, wherein:
the recommendation stop module is configured to be capable of stopping the display of the first image for each group of contents of the same series; and
the recommendation resumption module is configured to be capable of resuming the display of the first image for each group of contents of the same series.

16. The medium of claim 12, wherein:
the content comprises an electronic book, and
the recommendation module is configured to display an image of a front cover belonging to the electronic book.

17. The medium of claim 16, wherein the recommendation module, the recommendation stop module and the recommendation resumption module are configured to determine an electronic book whose title information included in metadata of the electronic book is identical as an electronic book of the same series.
